(19) United States
(12) Patent Application Publication
(10) Pub. No.: US 2009/0266014 A1
(43) Pub. Date: Oct. 29, 2009

(54) WINDOW WITH MULTIPLE MOUNTING FLANGES AND SYSTEMS AND METHODS OF INSTALLATION

(75) Inventor: James K. Green, Bellingham, WA (US)

Correspondence Address: DARBY & DARBY P.C., P.O. BOX 770, Church Street Station, New York, NY, 10008-0770, US

(73) Assignee: GREEN, JAMES K. DBA CANAMERICA, Bellingham, WA (US)

(21) Appl. No.: 12/111,072

(22) Filed: Apr. 28, 2008

(51) Int. Cl. E06B 3/06

(52) U.S. Cl. 52/204.55; 52/656.5; 52/745.15

(57) ABSTRACT

A building window for mounting to a rough opening defined in a stud frame wall. The building window includes at least one sheet of transparent or translucent material set in at least one sash which, in turn, is disposed in a frame. The frame includes a first mounting flange that extends outward from an outer surface of the frame in a direction approximately parallel to the plane of the at least one sheet of transparent or translucent material. The frame also includes a second mounting flange that extends outward from a first side of the frame in a direction approximately perpendicular to the plane of the at least one sheet of transparent or translucent material. The second mounting flange is configured and arranged to be secured to a perimeter edge of the rough opening defined in the stud frame wall.

### TECHNICAL FIELD

The present invention is directed to building windows. The present invention is also directed to a building window having multiple mounting flanges that facilitate mounting of the building window to a building wall from either side of the building wall.

### BACKGROUND

Installing building windows can be laborious, time-consuming, expensive, and even dangerous. Typically, a building window, such as an exterior building window, is installed by placing the building window in a rough framed opening (“rough opening”) from an exterior side of the rough opening. Thus, when a building window is to be installed in a rough opening that is above the reach of a window installer from the ground, the window installer may need to use a ladder, scaffolding, elevated platform or bucket, or the like to reach the rough opening in order to install the building window. Renting or buying equipment to reach rough openings can be expensive. Additionally, hauling building windows up to rough openings from an exterior side of a building can also be dangerous. Moreover, it can also be dangerous to hold a building window in position within a rough opening while attempting to mount the building window while precariously perched up off the ground.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective view of one embodiment of a window with a plurality of mounting flanges, according to the invention;

FIG. 1B is a schematic cross-sectional view of one embodiment of the window shown in FIG. 1A with a plurality of mounting flanges, according to the invention;

FIG. 2 is a schematic perspective view of one embodiment of a rough framed opening defined in a stud frame wall, according to the invention;

FIG. 3 is a schematic perspective view of one embodiment of sheets of flashing mounted around a rough framed opening defined in the stud frame wall shown in FIG. 2, according to the invention;

FIG. 4 is a schematic perspective view of one embodiment of the window shown in FIG. 1A configured and arranged to pass through a rough framed opening defined in the stud frame wall shown in FIG. 2, according to the invention;

FIG. 5A is a schematic side view of one embodiment of a portion of the window shown in FIG. 1B mounted to a rough framed opening defined in the stud frame wall shown in FIG. 2, according to the invention;

FIG. 5B is a schematic side view of another embodiment of a portion of the window shown in FIG. 1B mounted to a rough framed opening defined in the stud frame wall shown in FIG. 2, according to the invention;

FIG. 6A is a schematic side view of one embodiment of a portion of the window shown in FIG. 5A mounted to the rough framed opening shown in FIG. 5A with surface coverings placed over mounting flanges disposed on the window, according to the invention; and

FIG. 6B is a schematic side view of one embodiment of a portion of the window shown in FIG. 5B mounted to the rough framed opening shown in FIG. 5B with surface coverings placed over mounting flanges disposed on the window, according to the invention.

### DETAILED DESCRIPTION

The present invention is directed to building windows. The present invention is also directed to a building window having multiple mounting flanges that facilitate mounting of the building window to a building wall from either side of the building wall.

Building windows (“windows”) are generally designed to be installed from one certain side of rough opening. For example, exterior building windows are typically mounted to a rough opening defined in a stud frame wall from an exterior side of the stud frame wall. Many windows, such as exterior windows for new construction, include an exterior mounting flange that is used to secure the window to an exterior surface of the stud frame wall. During installation of a window, an installer may position him or herself on an exterior side of a stud frame wall and place the window within a rough opening defined in the stud frame wall so that the exterior mounting flange is flush with the exterior surface of the stud frame wall. The installer may then fasten the exterior mounting flange to the exterior surface of the stud frame wall while holding the window in place.

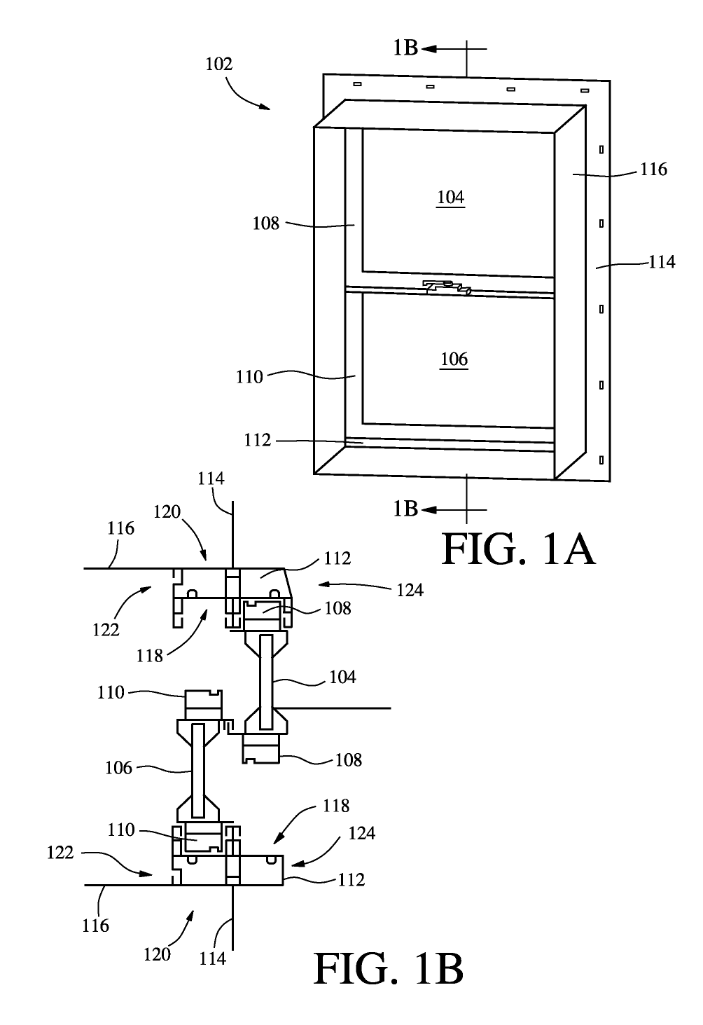

Sometimes it would be desirable to install a window from either side of a rough opening. In particular, it may sometimes be desirable to install an exterior window from inside a rough opening into which the window is to be installed. In at least some embodiments, a window with a second mounting flange is described which facilitates mounting of the window to a rough opening defined in a stud frame wall. In at least some embodiments, the window may be mounted to the rough opening by the second mounting flange from an interior side of the stud frame wall. FIG. 1A is a schematic perspective view of one embodiment of a window with a plurality of mounting flanges. The window 102 includes sheets of transparent or translucent material 104 and 106, sashes 108 and 110, and a frame 112. In FIG. 1A, the sheets of transparent or translucent material 104 and 106 are set within the sashes 108 and 110, respectively. The sashes 108 and 110, in turn, are set within the frame 112. The frame 112 includes a first mounting flange 114 and a second mounting flange 116. In at least some embodiments, the frame 112 also includes one or more tracks within which one or more of the sashes 108 or 110 may slide.

The sheets of transparent or translucent material 104 and 106 can be formed using any solid transparent or translucent material. Examples of suitable materials include glass, transparent plastic, and the like, as well as combinations thereof. The number of sheets of transparent or translucent material 104 and 106 disposed in the window 102 may vary. For example, there can be one, two, three, four, five, six, or more sheets of transparent or translucent material 104 and 106. As will be recognized, other numbers of sheets of transparent or translucent material 104 and 106 may also be used. In at least some embodiments, each of the sheets of transparent or translucent material 104 and 106 is substantially planar. In at least some embodiments, when a plurality of sheets of transparent or translucent material 104 and 106 are used, each of the sheets of transparent or translucent material 104 and 106 are parallel to each other. In at least some embodiments, when a plurality of sheets of transparent or translucent material 104 and 106 are used, at least one of the sheets of transparent or translucent material 104 and 106 may slide along one or more tracks disposed in the frame 112 to an open position. In at least some embodiments, when a plurality of sheets of transparent or translucent material 104 and 106 are used, at least one of the sheets of transparent or translucent material 104 and 106 may pivot to an open position.

In some embodiments, one sheet of transparent of translucent material is set within one sash. In other embodiments, multiple sheets of transparent of translucent material are set within one sash. The number of sashes 108 and 110 disposed in the window 102 may vary depending on the number of sheets of transparent of translucent material or the number of sheets of transparent of translucent material set within each sash. The sashes 108 and 110 can be formed using any building material suitable for securely holding sheets of transparent or translucent material 104 and 106. Examples of suitable materials include vinyl, aluminum, fiberglass, wood, and the like or combinations thereof. The sashes 108 and 110 may be formed in the desired shape by any process including, for example, extrusion, molding (including injection molding), casting, and the like.

The frame 112 can be formed using any building material suitable for securely holding sashes 108 and 110. Examples of suitable materials include vinyl, aluminum, fiberglass, wood, and the like or combinations thereof. The frame 112 may be formed in the desired shape by any process including, for example, extrusion, molding (including injection molding), casting, and the like.

In at least some embodiments, the at least one sheet of transparent or translucent material is formed in a rectangular shape. In at least some embodiments, the at least one sash is formed in a rectangular shape. In at least some embodiments, the frame is formed in a rectangular shape. In alternate embodiments, one or more of the at least one sheet of transparent or translucent material, the at least one sash, or the frame are formed in a non-rectangular shape including, for example, a circle, a semi-circle, a trapezoid, and the like

FIG. 1B is a schematic side view of one embodiment of the window 102. In FIG. 1B, the sheets of transparent or translucent material 104 and 106 are set in the sashes 108 and 110, respectively. The sashes 108 and 110, in turn, are disposed in the frame 112. The frame 112 includes an inner surface 118, an outer surface 120, a first side 122, and a second side 124. The frame 112 also includes the first mounting flange 114 and the second mounting flange 116. The first mounting flange 114 extends from the outer surface 120 in a direction that is approximately parallel with the sheets of transparent or translucent material 104 and 106. In at least some embodiments, first mounting flange 114 is configured and arranged to align with an exterior surface of a stud frame wall when the window 102 is placed within a rough opening defined in the stud frame wall. In at least some embodiments, the first mounting flange 114 is configured and arranged to be fastened to the stud frame wall 204 by one or more fasteners including, for example, adhesive, nails, screws, staples, rivets, bolts, clamps, tape, and the like. In at least some embodiments, the first mounting flange 114 includes one or more fastener apertures configured and arranged to facilitate fastening of the first mounting flange 114 to an exterior surface of a stud frame wall. In some embodiments, the first mounting flange 114 is a unitary structure. In other embodiments, the first mounting flange 114 is a multi-piece structure. In some embodiments, the first mounting flange 114 and the frame 112 are a unitary structure. In other embodiments, the first mounting flange 114 and the frame 112 are separate structures that are assembled together after being individually formed.

The second mounting flange 116 extends from the first side 122 of the frame 112 in a direction that is approximately perpendicular to the sheets of transparent or translucent material 104 and 106. In at least some embodiments, the second mounting flange 116 is configured and arranged to align with a perimeter edge of a rough opening defined in a stud frame wall. In at least some embodiments, the second mounting flange 116 is configured and arranged to be fastened to the perimeter edges of the rough opening by one or more fasteners including, for example, adhesive, nails, screws, staples, rivets, bolts, clamps, tape, and the like. In at least some embodiments, the second mounting flange 116 includes one or more fastener apertures configured and arranged to facilitate fastening of the second mounting flange 116 to a rough opening. In some embodiments, the second mounting flange 116 is a unitary structure. In other embodiments, the second mounting flange 116 is a multi-piece structure. In some embodiments, the second mounting flange 116 and the frame 112 are a unitary structure. In other embodiments, the second mounting flange 116 and the frame 112 are separate structures that are assembled together after being individually formed. In some embodiments, the first mounting flange 114, the second mounting flange 116, and the frame 112 are a unitary structure.

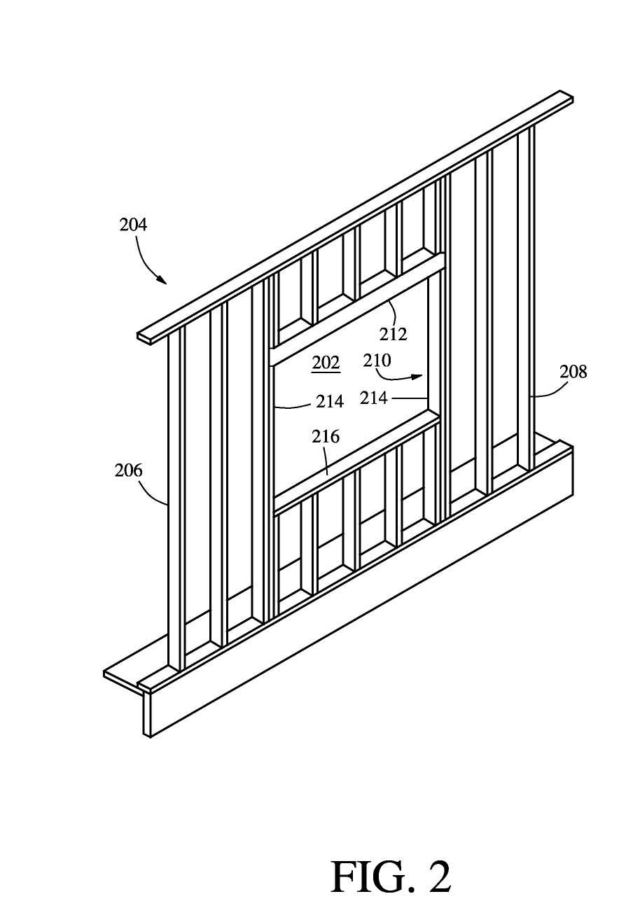

FIG. 2 is a schematic perspective view of one embodiment of a rough opening 202 defined in a stud frame wall 204. The stud frame wall 204 includes an interior side 206 and an exterior side 208. The rough opening 202 includes a perimeter edge 210 which, in turn, includes a head 212, sides 214, and a sill 216. In at least some embodiments, the shape of the rough opening 202 is similar to the shape of the frame 112. In at least some embodiments, the dimensions of the rough opening 202 are at least as great as the relative dimensions of the frame 112. In a preferred embodiment, the rough opening 202 is shaped similarly to the frame 112 (without the first and second mounting flanges 114 and 116, respectively), with the dimensions of the rough opening 202 are slightly larger than the corresponding dimensions of the frame 112 (without the first and second mounting flanges 114 and 116, respectively).

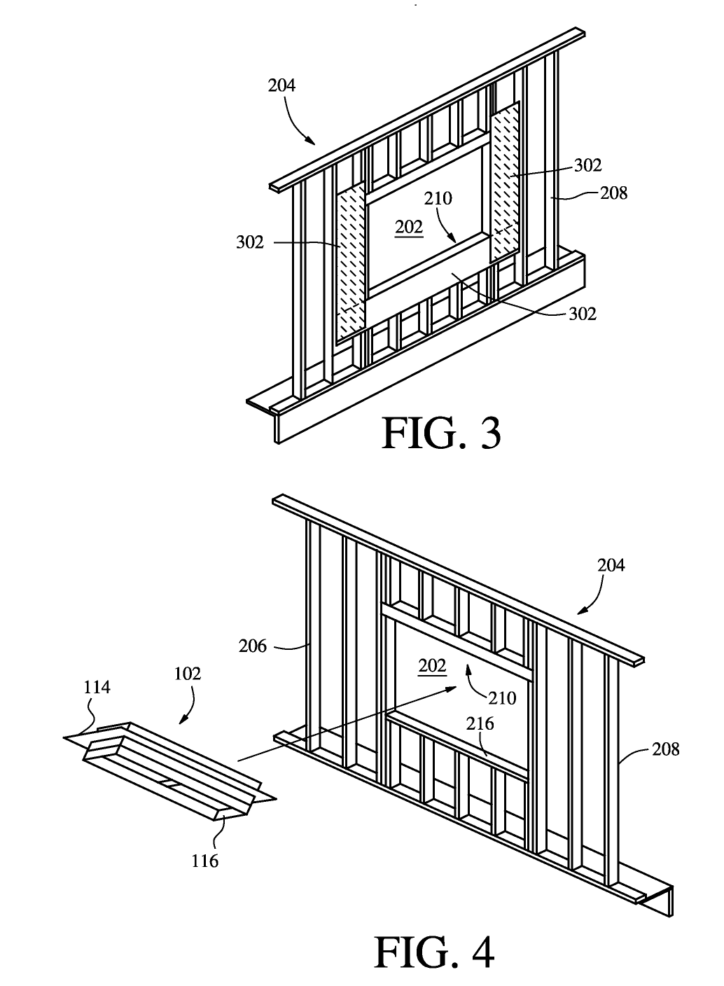

In at least some embodiments, prior to mounting the window 102 to the rough opening 202 defined in the stud frame wall 204, flashing is secured to the exterior side 208 of the stud frame wall 204 around at least a portion of the perimeter edge 210 of the rough opening 202. FIG. 3 is a schematic perspective view of one embodiment of sheets of flashing 302 mounted around the perimeter edge 210 of the rough opening 202 defined in the stud frame wall 204. In at least some embodiments, the flashing 302 ameliorates water penetration into the stud frame wall 204 around the rough opening 202 by draining water away from the first mounting flange 114 when the window 102 is mounted to the rough opening 202. In at least some embodiments, flashing 302 is not placed on the stud frame wall 204.

In at least some embodiments, the window 102 may be installed from the interior side 206 of the stud frame wall 204. In at least some embodiments, an installer may apply one or more sealants to the side of the first mounting flange 114 facing the second mounting flange 116. Many different types of sealants may be used including, for example, polysulfide rubber, silicone, acrylic latex, butyl rubber, and polyurethane. In at least some embodiments, the installer may place one or more shims along a portion of the sill 216 to make the rough opening 202 more square, plumb, or level. In one specific embodiment, one-quarter inch (0.64 cm) shims are used.

In at least some embodiments, the installer may position him or her self on the interior side 206 of the stud frame wall 204 and pass the window 102 through the rough opening 202. FIG. 4 is a schematic perspective view of one embodiment of the window 102 in position to be passed through the rough opening 202 defined in the stud frame wall 204. In at least some embodiments, the window 102 may need to be angled to fit through the rough opening 202. Once the window 102 is passed through the rough opening 202 so that the installer is in the interior side 206 and the window 102 is in the exterior side 208, the window 102 may be rotated to an upright position so that the second mounting flange 116 faces into the rough opening 202 and the sealant on the first mounting flange 114 faces into the exterior surface 208 of the stud frame wall 204. When the window 102 is rotated into position, the window 102 may be brought into position (i.e., pulled towards the installer) within the rough opening 202 so that the second mounting frame 116 is flush with the perimeter edge 210 of the rough opening 202 and the sealant on the first mounting flange 114 contacts the flashing 302 (or the exterior surface 208 of the stud frame wall 204) around the perimeter of the rough opening 202 to create a positive seal between the first mounting flange 114 and the flashing 302 (or the exterior surface 208 of the stud frame wall 204) around the perimeter of the rough opening 202.

Once the window 102 is positioned within the rough opening 202 and the first mounting flange 114 is sealed against the flashing 302 (or the exterior surface 208 of the stud frame wall 204) around the perimeter of the rough opening 202, the second mounting flange 116 may be fastened to the sill 216. In at least some embodiments, an installer may hold the window 102 in place and secure the second mounting flange 116 to the sill 216 by passing one or more fasteners, such as one or more nails or one or more screws or one or more bolts, through the second mounting flange 116 and into the sill 216.

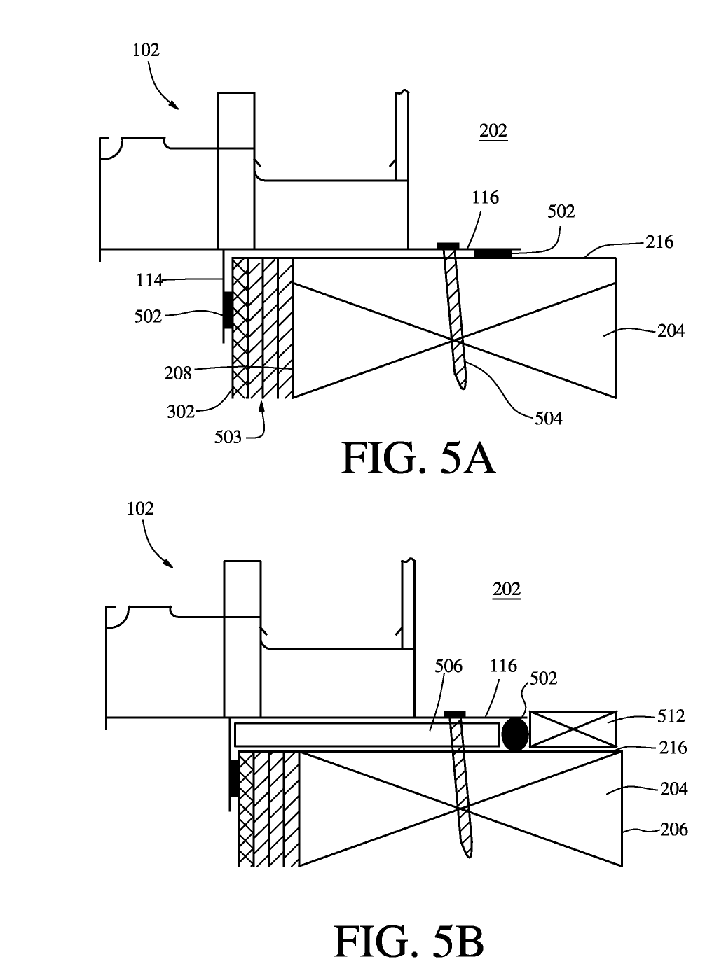

FIG. 5A is a schematic side view of one embodiment of a lower portion of the window 102 mounted to the sill 216 of the rough opening 202 defined in the stud frame wall 204. In FIG. 5A, the first mounting flange 114 is sealed by a sealant 502 to flashing 302 which, in turn, is secured against one or more layers of wood sheathing 503 which, in turn, is secured against the exterior side 208 of the stud frame wall 204. In alternate embodiments, the flashing 302 may not be used and the sealant 502 may be applied directly to the exterior side 208 of the stud frame wall 204. In FIG. 5A, the second mounting flange 116 is shown secured to the sill 216 by a fastener 504. In at least some embodiments, the window 102 may be further sealed by applying sealant, such as sealant 502, between the second mounting flange 116 and the sill 216 in proximity to a distal edge of the second mounting flange 116.

As discussed above, in at least some embodiments the installer may place one or more shims along a portion of the sill 216 to make the rough opening 202 more square, plumb, or level. FIG. 5B is a schematic side view of another embodiment of a portion of the window 102 mounted to the sill 216 of the rough opening 202 defined in the stud frame wall 204. In FIG. 5B, a shim 506 is positioned between the second mounting flange 116 and the sill 216. In at least some embodiments, when one or more shims, such as shim 506, are positioned between the second mounting flange 116 and the sill 216, the fastener 504 may be passed through the second mounting flange 116, the one or more shims (e.g., shim 506), and into the sill 216. In at least some embodiments, the one or more shims, such as the shim 506, may be inset from a distal edge of the second mounting flange 116 and sealant 502 may be applied between the second mounting flange 116 and the one or more shims.

In at least some embodiments, once a portion of the second mounting flange 116 is secured to the sill 216, the window 102 may be plumbed and leveled. In at least some embodiments, once the window 102 is plumb and level, shims my be placed at desired intervals along the head 212 and sides 214 of the rough opening 202 and the second mounting flange 116 may be fastened to the head 212 and sides 214 by passing one or more fasteners through the selectively-placed shims. In one specific embodiment, the shims are placed at approximately twelve-inch (30.48 cm) intervals across the head 212 and sides 214 of the rough opening 202.

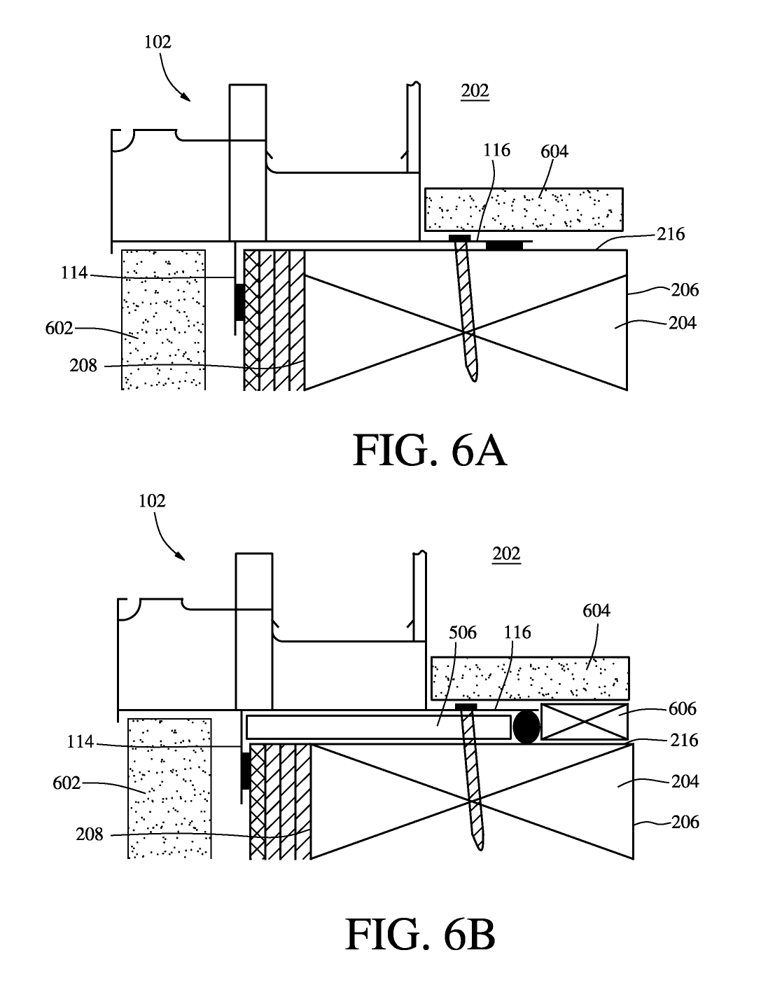

As shown in FIGS. 6A and 6B, one or more surface coverings may be laid over the first mounting flange 114 or the second mounting flange 116. In at least some embodiments, once the window 102 is mounted to the rough opening 202, the first mounting flange 114 may be covered by one or more exterior surface materials 602, such as stucco, siding, and the like or combinations thereof. Additionally, in at least some embodiments, one or more additional waterproof barriers may be applied to the exterior surface 208 of the stud frame wall 204. In at least some embodiments, once the window 102 is mounted to the rough opening 202, the second mounting flange 116 may be covered by one or more interior surface substrates 604, such as a stool, drywall, plasterboard, wallboard, and the like.

In at least some embodiments (as shown in FIG. 6B), one or more additional backing shims, such as backing shim 606, may be used to provide backing for facilitating level or plumb fastening of one or more interior surface substrates, such as interior surface substrate 604, to the sill 216 or to the interior surface 206 of the stud frame wall 204. In at least some embodiments, the one or more backing shims, such as backing shim 606, are the same shims as the non-backing shims, such as shim 506.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A building window comprising:
at least one sheet of transparent or translucent material, each sheet of transparent or translucent material having a substantially planar shape, a first side, and a second side;
at least one sash, each of the at least one sashes disposed around a perimeter of at least one sheet of transparent or translucent material; and
a frame having an inner surface, an outer surface, a first side, and a second side, each sash disposed in the frame so that the first side of the frame aligns with the first side of the at least one sheet of transparent or translucent material and the second side of the frame aligns with the second side of the at least one sheet of transparent or translucent material, the frame comprising
a first mounting flange coupled to the outer surface of the frame, the first mounting flange extending outward from the outer surface of the frame in a direction approximately parallel to the plane of the at least one sheet of transparent or translucent material, and
a second mounting flange coupled to the first side of the frame, the second mounting flange extending outward from the first side of the frame in a direction approximately perpendicular to the plane of the at least one sheet of transparent or translucent material.

2. The window of claim 1, wherein the building window is configured and arranged for mounting to at least one perimeter edge of a rough opening in a stud frame wall.

3. The window of claim 2, wherein the second mounting flange is configured and arranged for aligning with the perimeter edges of the rough opening of the stud framed wall.

4. The window of claim 3, wherein the second mounting flange is configured and arranged for coupling to at least one of the perimeter edges of the rough opening by at least one of a nail, a screw, a staple, a rivet, a bolt, a clamp, tape, or an adhesive.

5. The window of claim 3, wherein the second mounting flange configured and arranged for being sandwiched between the rough opening and at least one interior surface substrate.

6. The window of claim 2, wherein the stud frame wall is an exterior wall.

7. The window of claim 1, wherein the at least one sheet of transparent or translucent material is formed from glass.

8. The window of claim 1, wherein the frame is formed from at least one of vinyl, aluminum, fiberglass, or wood.

9. The window of claim 8, wherein the window frame is extruded vinyl, aluminum, or fiberglass.

10. A method for installing a building window, the method comprising:
placing the building window into a rough opening defined in a stud frame wall, the building window comprising a frame wrapped around at least one sheet of transparent or translucent material, the frame comprising a first mounting flange and a second mounting flange, the rough opening having a perimeter edge that comprises a head, sides, and a sill, the stud frame wall having an interior side and an exterior side;
adjusting the positioning of the window within the rough opening so that the first mounting flange is approximately flush with the exterior side of the stud frame wall and the second mounting flange is approximately flush with the perimeter edge of the rough opening;
fastening the second mounting flange to the sill of the rough opening; and
fastening the second mounting flange to the head and sides of the rough opening.

11. The method of claim 10, wherein placing the building window into the rough opening defined in the stud frame wall comprises passing the building window through the rough opening from the interior side of the stud frame wall to the exterior side of the stud frame wall.

12. The method of claim 10, further comprising placing at least one shim on the sill to level or plumb the sill prior to placing the building window into the rough opening defined in the stud frame wall.

13. The method of claim 10, wherein fastening the second mounting flange to the head and sides of the rough opening comprises placing at least one shim between the second mounting flange and the head and sides of the rough opening and fastening the second mounting flange to the head and sides of the rough opening through the at least one shim.

14. The method of claim 10, further comprising plumbing and leveling the window subsequent to fastening the second mounting flange to the sill of the rough opening.

15. The method of claim 10, further comprising placing at least one backing shim between the second mounting flange and the perimeter edge of the stud frame wall so that each of the at least one backing shims are approximately flush with the interior surface of the stud frame wall.

16. The method of claim 10, further comprising securing at least one sheet of flashing to the exterior surface of the stud frame wall in proximity to the perimeter edge of the rough opening.

17. The method of claim 16, further comprising applying at least one sealant to the first mounting flange of the building window so that the at least one sealant contacts at least one of the exterior side of the stud frame wall or the flashing to form a positive seal when the positioning of the building window is adjusted within the rough opening so that the first mounting flange is approximately flush with the exterior side of the stud frame wall.

18. The method of claim 10, further comprising applying at least one sealant between at least a portion of the second mounting flange and at least a portion of the perimeter edge of the rough opening.

19. The method of claim 10, further comprising applying at least one exterior surface material over at least a portion of the first mounting flange.

20. The method of claim 10, further comprising applying at least one interior surface substrate over at least a portion of the second mounting flange.
